(19) United States
(12) Patent Application Publication
(10) Pub. No.: US 2013/0060712 A1
(43) Pub. Date: Mar. 7, 2013

(54) Bulk Distribution Method

(71) Applicants: Ali Esmaili, Emmaus, PA (US); Sharad Kumar, Orefield, PA (US); Brian Keith Petersen, Fogelsville, PA (US); Catherine Catino Latshaw, Fogelsville, PA (US)

(72) Inventors: Ali Esmaili, Emmaus, PA (US); Sharad Kumar, Orefield, PA (US); Brian Keith Petersen, Fogelsville, PA (US); Catherine Catino Latshaw, Fogelsville, PA (US)

(73) Assignee: AIR PRODUCTS AND CHEMICALS, INC., Allentown, PA (US)

(21) Appl. No.: 13/697,671

(22) PCT Filed: May 24, 2010
(86) PCT No.: PCT/US10/35973

§ 371 Date: Nov. 13, 2012

(51) Int. Cl. G06Q 10/08; G06Q 50/28

(52) U.S. Cl. 705/341

(57) ABSTRACT

Fractionating and allocating a cost of delivery of a product to at least one customer from at least one plant where the at least one customer is at a first location and requires a first amount of product, and wherein the plant is at a second location and has a capacity to produce and distribute a second amount of product, the method comprising: obtaining, historical actual trip data; eliminating, outlier data to calculate cleaned trip data; calculating a fixed cost for delivery to the at least one customer; calculating a variable cost for the delivery to the at least one customer; calculating an actual fractional cost for the delivery of the product to the at least one customer: and calculating a predicted fractional cost for the delivery of the product to the at least one customer.

### BACKGROUND

A typical Supply Chain Management (SCM) problem consists of optimizing raw material procurement, production planning, inventory management, and final product distribution. These sub-problems are coupled and profit maximization or cost minimization depends on adequate solutions to each of them and especially to their combination. The complexity of the general problem is daunting: there may be a plurality (including possibly a very large number) of raw material and energy suppliers, production plants, production modes, depots, terminals, products, delivery modes, delivery vehicles, vehicle types, and customers. Some or all of these elements may be stochastic with uncertainties imposed by uncontrolled exogenous factors. Prices for inputs and other parameters may change dynamically. The system may be highly constrained with production limitations, product pick-up or delivery time windows, plant and vehicle maintenance schedules, limitations on driver availability, etc. Complicating the picture even further is that plans may have to be generated frequently, perhaps on a daily basis, limiting the time available to find solutions.

Because of the constraints, stochasticity, size, and complexity of the general Supply Chain Management problem, exact optimal solutions and even feasible, high-quality partial optima are usually impossible to produce with practical computing power and time. To generate production and distribution plans for practical use, the general problem is usually highly simplified leading to generation of merely feasible solutions or to significantly suboptimal solutions, thus, compromising profits.

One of the most difficult sub-problems of the general Supply Chain Management problem is that of product distribution. Specific instances for which partial or approximate solutions have been discussed are known, for example, as the Traveling Salesman Problem (TSP), the Multiple Traveling Salesman Problem (MTSP), the Vehicle Routing Problem (VRP), or the Multiple-Depot Vehicle Routing Problem with Time Windows (MDVRPTW). Rapid optimal solutions to this problem would not only enable efficient distribution plans to be made, but also provide more optimal solutions for real scenarios where distribution is tightly coupled to production and to inventory management. If the solution is rapid enough, enumerative, iterative, or other methods may be used to optimize the coupled problem. In this case and for many similar ones, a different method may be needed for determining how a distribution plan will actually be carried out, rather than determining another optimal plan, which might not be practical to implement. In order to partially decouple and solve portions of the general Supply Chain Management problem, it may be valuable, useful, and “good enough” to simply predict the cost of a given sub-problem and not necessarily determine a detailed solution with specification of all of the decision variables. For example, a model for determining the cost of the distribution problem might enable a rapid solution of the coupled production plus distribution problem without determining the detailed nature (routes, delivery times, etc.) of the solution for distribution. Of course detailed solutions to the distribution problem are the best to implement, provided that the system can tolerate long implementation times and higher costs typically associated with them.

The production and delivery of products from multiple production sites in a region, or continent to multiple customers, for example, is a common optimization problem faced by many companies. In particular, the optimization of the coupled problem of determining production plans at a multitude of production sites along with determining delivery plans to meet predicted and requested customer demands is very challenging. In these cases, the distribution problem is often tightly coupled to the production and/or storage scheme: where and when should the product be manufactured and stored in order to facilitate the lowest total cost of production, storage, and delivery? Prevalent solutions for optimizing distribution networks are mostly deterministic in nature. Some solutions involve looking at direct line distances between every point in the network as well as using a more realistic distance/cost measure, with the latter approach being the most prevailing for solving these types of network optimization scenarios. These problems have been extensively studied and solutions implemented, but most often, the predictions are infeasible in a practical sense owing to long solution times and exorbitant computing costs.

### BRIEF SUMMARY

The described embodiments satisfy the need in the art by providing a rapid solution to the distribution problem by quickly generating a distribution cost associated with supplying a particular customer from a particular production site. In turn, this rapid solution to the distribution problem enables efficient optimization of the combined production plus inventory plus distribution problem.

In one embodiment, a computer-implemented method for fractionating and allocating a cost of delivery of a product to at least one customer from at least one plant is disclosed, wherein the at least one customer is at a first location and requires a first amount of the product to be delivered, and wherein the plant is at a second location and has a capacity to produce and distribute a second amount of the product, the method comprising' obtaining, with an electronic processor from an electronic data repository, historical actual trip data for the at least one customer receiving the product from the at least one plant; eliminating, with the electronic processor, outlier data from the historical actual trip data to calculate cleaned trip data; calculating, with the electronic processor, a fixed cost for delivery of the product to the at least one customer using the cleaned trip data; calculating, with the electronic processor, a variable cost for the delivery of the product to the at least one customer using the cleaned trip data; calculating, with the electronic processor, an actual fractional cost for the delivery of the product to the at least one customer from the second location; and calculating, with the electronic processor, a predicted fractional cost for the delivery of the product to the at least one customer from the second location.

In another embodiment, a computer system for fractionating and allocating a cost of delivery of a product to at least one customer from at least one plant is disclosed, wherein the at least one customer is at a first location and requires a first amount of the product to be delivered, and wherein the plant is at a second location and has a capacity to produce and distribute a second amount of the product, the system comprising: an electronic data repository; and an electronic processor, configured to: obtain, from the electronic data repository, historical actual trip data for the at least one customer receiving the product from the at least one plant; eliminate outlier data from the historical actual trip data to calculate cleaned trip data; calculate a fixed cost for delivery of the product to the at least one customer using the cleaned trip data; calculate a variable cost for the delivery of the product to the at least one customer using the cleaned trip data; calculate an actual fractional cost for the delivery of the product to the at least one customer from the second location; and calculate a predicted fractional cost for the delivery of the product to the at least one customer from the second location.

In yet another embodiment, a computer-readable storage medium encoded with instructions configured to be executed by a processor, the instructions which, when executed by the processor, cause the performance of a method for fractionating and allocating a cost of delivery of a product to an at least one customer from an at least one plant is disclosed, wherein the at least one customer is at a first location and requires a first amount of the product to be delivered, and wherein the plant is at a second location and has a capacity to produce and distribute a second amount of the product, the method comprising: obtaining, with an electronic processor, historical actual trip data for the at least one customer receiving the product from the at least one plant; eliminating, with the electronic processor, outlier data from the historical actual trip data to calculate cleaned trip data; calculating, with the electronic processor, a fixed cost for delivery of the product to the at least one customer using the cleaned trip data; calculating, with the electronic processor, a variable cost for the delivery of the product to the at least one customer using the cleaned trip data; calculating, with the electronic processor, an actual fractional cost for the delivery of the product to the at least one customer from the second location; and calculating, with the electronic processor, a predicted fractional cost for the delivery of the product to the at least one customer from the second location.

### BRIEF DESCRIPTION OF SEVERAL VIEWS OF THE DRAWINGS

FIG. 1 illustrates an example delivery scenario, according to an exemplary embodiment of the present invention;

FIG. 2 illustrates an example cost allocation scenario, according to an exemplary embodiment of the present invention;

FIG. 3 illustrates one example process, according to an exemplary embodiment of the present invention; and

FIG. 4 illustrates one exemplary system, according to an example embodiment of the present invention.

### DETAILED DESCRIPTION

The foregoing summary, as well as the following detailed description of exemplary embodiments, is better understood when read in conjunction with the appended drawings. For the purpose of illustrating embodiments, there is shown in the drawings exemplary constructions; however, the invention is not limited to the specific methods and instrumentalities disclosed.

Embodiments of the present invention consist of using a combination of historical information on actual distribution operations, combined with cost models and other information, to rapidly generate an estimate of the cost of a distribution plan, and potentially, but not necessarily, producing a detailed solution for the distribution plan. The estimated cost can then be used for different purposes where examples include, but are not limited to, solving the combined production plus inventory plus distribution problem to find an optimal production and inventory plan, generating new sales opportunities, and developing customer pricing models to name a few.

There could be a myriad of financial benefits associated with using the proposed approach. Significant savings could result from reduced computational time, since the first pass solution to the distribution problem is already available from the proposed approach, when solving the combined production-distribution optimization problem. This should have large positive implications for different industries like oil refineries, chemicals, plastics, automotive to name a few, where solving the combined problem in the quickest time-frame improves decision making and ultimately contributes positively to the business bottom line. Additionally the proposed approach could also have significant utility in boosting the production savings from supply chain optimization by improving the quality of sourcing decisions made, since the typical costs for any possible plant-customer pairing are available to those responsible for planning beforehand and would let them choose the most profitable sourcing scenarios. Potential benefits could have a lot of variance associated with them since they would be positively correlated with the total number of trips made in any application. For a scenario with thousands of trips being planned and undertaken every year, there could approximately be productivity savings of the order of 5-10% of the total variable cost, whereas this number could be as high as 15-20% for a scenario involving millions of trips. One exemplary embodiment provides a method to optimize the distribution costs of a plurality of production sites when supplying product to multiple customers through different trips. The business processes of planning and scheduling can be improved by using a combination of recent and historical trip data and business cost parameters to develop accurate models for calculating the fixed costs and variable costs associated with past trips. This is followed by characterizing some measure or measures such as the mean and optionally the distribution of some variables (e.g., number of stops, delivered volume, etc.) related to unique customer-plant pairings for past trips that have occurred more than once. The next step is a regression model to calculate the fractionated costs based on a set of variables which may include distances, times, costs, selection and order of customer visits, layovers, and any other known information which might influence the distance, time, cost, reproducibility, and success rate for deliveries. This is then used to create a matrix for each possible plant-customer pairing for different variables influencing the cost like distance between plant-customer, average number of stops for each customer, average amount or volume driven to each customer, and other variables that could have an effect on the cost. Finally a unique cost is obtained for each customer-plant pairing using the regression model for both trips that have occurred in the past as well as possible unrealized trips in the future. Other variables that may be considered and factored into the cost analysis include, but are not limited to, customer type, weather, traffic, and routing conditions.

Benefits of this approach for calculating distribution costs include:
1. The ability to predict the distribution cost without actually solving the distribution/routing problem. This further enables solving the production and sourcing optimization problem;
2. Output from the production plus inventory plus distribution problem optimization resulting in significant savings for planning future trips;
3. The fractional cost information for realized trips as well as unrealized trips provide useful information on “higher cost pockets' and “lower cost pockets” to the overall network of production sites;
4. The fractional cost information may be additionally used to optimize areas where currently the company pays a premium price to supply product to various customers; and
5. First-pass estimation of the cost to add any new customer—plant combination and determine the most profitable choice.

In the example described below, the proposed invention may be applied to a variety of manufacturing facilities including air separation plants, plastics manufacturing, typical chemical plants like oil and gas refineries, food, textiles, paper, or other manufacturing or supply factories. In the simplest scenario, a truck is loaded with the appropriate product at the production site: the truck travels to a customer and off-loads the product at the customer site based on the demand, and the truck returns back to the production site. The situation is challenging with the presence of thousands of customers (or groups of customers), which are present in different geographical areas, and also have different product demands. As a result, trips are planned in order to cover the largest number of customers in a single trip in an attempt to minimize miles driven and, hence, lower distribution costs. Sometimes, these customers or groups of customers may be in the same industry, and thus, grouped together or binned together to lower distribution costs. This approach enables the production site to satisfy different size orders for the customers in a single trip. Multiple trips of this kind may be planned and scheduled every year, where sourcing decisions are made for a single customer or a series of customers.

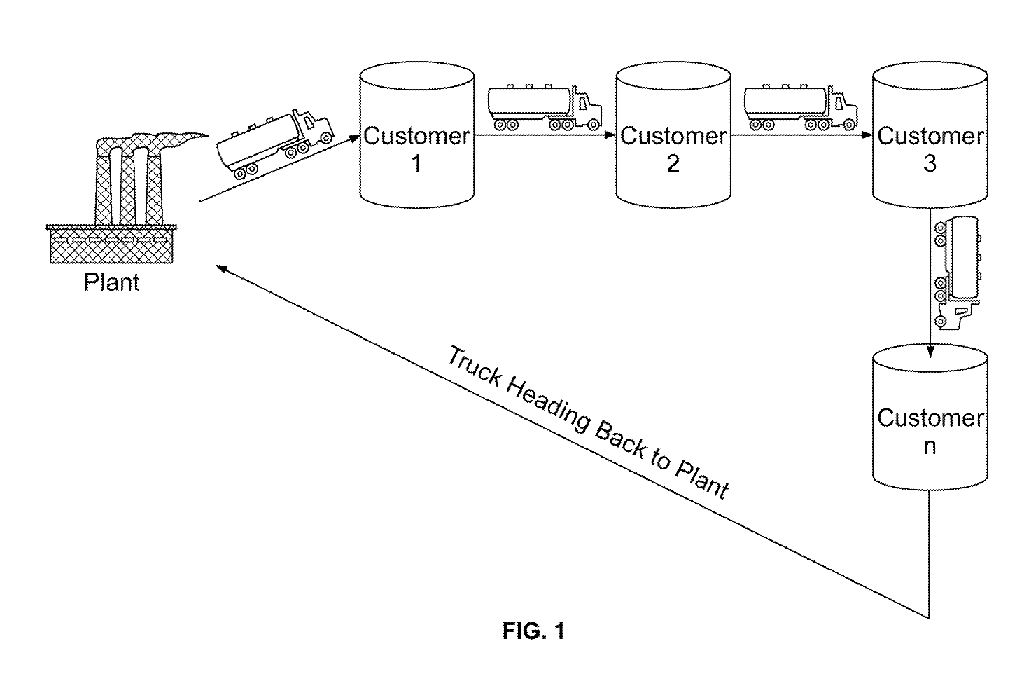

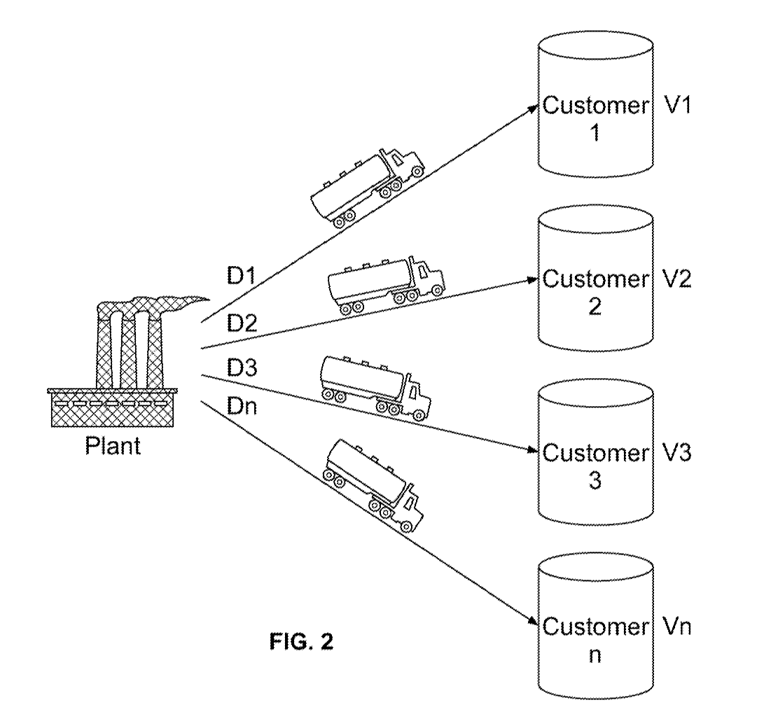

To better illustrate the proposed process, a schematic diagram of the process is provided in FIGS. 1 and 2. FIG. 1 shows a schematic of a typical exemplary trip for a set number of customers; Customer 1, Customer 2, Customer 3 and Customer n (for any customer “n”)) and plant (Plant). FIG. 2 shows the proposed approach of fractionating the costs for each of those customers.

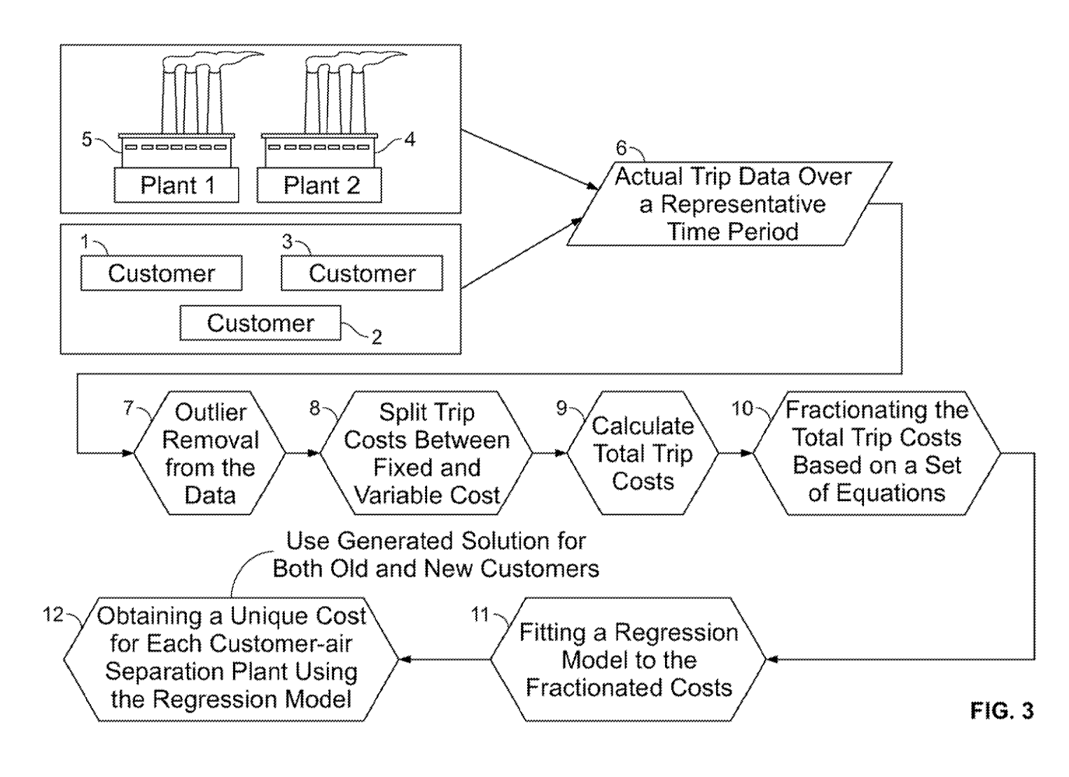

FIG. 3 illustrates one example process, according to an example embodiment of the present invention. Customers 1, 2, and 3 may be delivery recipients of either or both of plant 1 (5) and/or plant 2 (4), e.g., as illustrated in FIG. 1. At 6, the example process may collect actual trip data over a representative time period. This time period may be configured by a user, and subsequently modified. For example, a user may want a twelve month trailing collection of data points, or may want the data from some event-point going forward (e.g., when the delivery vehicles switched to fuel-efficient models).

Table 1 provides historic actual data available for a sequence of trips as depicted in FIGS. 1-2. Actual detailed trip information may be obtained over a representative period comprising: start point; segment end point; activity log (whether that segment of the trip is “load product”, “delivery” or “return trip”); actual amount or volume delivered; number of cumulative stops made during the trip; actual distance travelled during the trip; and distance from originating plant to segment end point.

TABLE 1

| | | | | | | | Distance | |
|---|---|---|---|---|---|---|---|---|
| | | | | | | Actual | from | |
| | | | | | Cumulative | Amount | Originating | |
| | | | | | Miles | Delivered | Plant to | |
| | | | | Actual | driven | (Standard | Segment | Number of |
| | | Segment | | Miles | during the | Cubic | End Point | Cumulative |
| Trip | Start Point | End Point | Activity Log | Driven | trip | Feet) | (Miles) | Stops |
| Trip 1 | Originating | — | Load | 0 | 0 | 0 | 0 | — |
| | Plant 1 | | Product | | | | | |
| Trip 1 | Plant 1 | Customer 1 | Delivery | 50 | 50 | 300000 | 50 | 1 |
| Trip 1 | Customer 1 | Customer 2 | Delivery | 30 | 80 | 200000 | 60 | 2 |
| Trip 1 | Customer 2 | Plant 1 | Return Trip | 60 | 140 | 0 | 0 | — |
| Trip 2 | Originating | — | Load | 0 | 0 | 0 | 0 | — |
| | Plant 2 | | Product | | | | | |
| Trip 2 | Plant 2 | Customer 3 | Delivery | 40 | 40 | 250000 | 40 | 1 |
| Trip 2 | Customer 3 | Plant 2 | Return Trip | 40 | 80 | 0 | 0 | — |
| Trip 3 | Originating | — | Load | 0 | 0 | 0 | 0 | — |
| | Plant 3 | | Product | | | | | |
| Trip 3 | Plant 3 | Customer 4 | Delivery | 100 | 100 | 100000 | 100 | 1 |
| Trip 3 | Customer 4 | Customer 5 | Delivery | 25 | 125 | 200000 | 110 | 2 |
| Trip 3 | Customer 5 | Customer 1 | Delivery | 50 | 175 | 100000 | 125 | 3 |
| Trip 3 | Customer 1 | Plant 3 | Return Trip | 75 | 250 | 0 | 0 | — |

Here the segment” for a trip is defined as each leg of the trip, where an activity (load product, delivery, and return trip) has occurred. As an example, Trip 1 has 4 segments, Trip 2 has 3 segments and Trip 3 has 5 segments respectively. The distance from the originating point to segment end points may be obtained using commercially available software like Microsoft® Streets & Trips 2009, for example, because the addresses for the start and end points are known.

It is possible that the trip data obtained over an extensive time period might have outliers present in it. The outliers may be present in the data in various forms including data missing for a trip segment or incorrectly reported miles driven to name a few. This outlier data should be removed from the trip data before the proposed approach can be applied to it. At 7, the example process may remove all such outlier data. The filtering criteria for outlier removal may also be set by a user to produce a data-set without unwanted outliers, e.g., the trip data presented in Table 1 does not have these typical outliers included.

Next, at 8, the example process may calculate fixed trip costs and variable trip costs, and categorize each cost into one or the other. Table 2 contains the data parameters for variables including; time spent in plant loading, hourly wages, driver labor, fuel rate, miles per gallon, and the hourly wages at the plants all of which impact the fixed costs and variables costs for the trip. Additionally other variables such as fringe costs and maintenance costs may also affect the trip costs.

TABLE 2

| | |
|---|---|
| Time spent in plant loading product (hr) | 5 |
| Time to unload product (hr) | 5 |
| Driver Labor ($/mile) | 1 |
| Estimated Fuel Rate ($/gal) | 3.5 |
| Miles per gallon | 8 |
| Plant 1 Hourly Wage Rate ($/hr) | 50 |
| Plant 2 Hourly Wage Rate ($/hr) | 55 |
| Plant 3 Hourly Wage Rate ($/hr) | 60 |

Equations 1, 2, and 3 listed below are used to calculate the Fixed Costs, Variable Costs, and Total Costs for every trip. The Fixed Costs (FC) is calculated as follows:

FC=((T_{L}+Tᵤ)·HWR) (1)

where,

T_{L}=Time Spent in Plant Loading Product;

T_{U}=Time to Unload Product; and

HWR=Hourly Wage Rate.

The Variable Costs (VC) is calculated as follows.

$$V C = ( ( \frac{F R}{M P G} ) + D L ) \cdot {M}_{D} \qquad ( 2 )$$

where,

FR=Estimated Fuel Rate;

MPG=Miles per gallon;

DL=Driver Labor: and

M_{D}=Miles Driven.

At 9, the example process may calculate the Total Trip Costs, which is calculated by adding the Fixed Costs and Variable Costs for the trip as shown in Equation 3:

TC=(FC+VC) (3)

Next, at 10, the example process may fraction the total trip costs (TC) based on a set of equations, e.g., as described below. The Fractional Volume (FV) for any Customer (n) on a trip is calculated using Equation 4, It should be noted that “Volume” is used throughout this document in the general sense, meaning the amount or quantity of a product, and should not be restricted to only fluid volume. For example, if the product being delivered to Customer (n) is Digital Video Discs (DVD's), then the Volume (Vₙ) is the amount of DVD's being delivered to Customer (n). The Fractional Volume represents the fraction of the Volume (V) delivered to that customer out of the total volume delivered during a certain trip. The Fractional Volume is calculated as follows:

$${( FV )}_{n} = \frac{{V}_{n}}{{V}_{1} + {V}_{2 +} {V}_{3} + … {V}_{n}} \qquad ( 4 )$$

where,

Vₙ=Volume delivered to Customer (n);

V₁=Volume delivered to Customer 1;

V₂=Volume delivered to Customer 2; and

V₃=Volume delivered to Customer 3.

The Fractional Distance-Volume-Product (FDVP) for any Customer (n) on a trip is calculated using equation 5. The Fractional Distance-Volume-Product includes contributions from the distance (D) from each originating point in a segment to its destination along with the volume delivered in that segment. The Fractional Distance-Volume-Product (FDVP) for any Customer (n) on a trip is calculated as follows:

$${( FDVP )}_{n} = \frac{{D}_{n} {V}_{n}}{{D}_{1} {V}_{1} + {D}_{2} {V}_{2 +} {D}_{3} {V}_{3} + … {D}_{n} {V}_{n}} \qquad ( 5 )$$

where,

Dₙ=distance from originating point to Customer (n)

Vₙ=Volume delivered to Customer n;

D₁=distance from originating point to Customer 1;

V₁=Volume delivered to Customer 1;

D₂=distance from originating point to Customer 2;

V₂=Volume delivered to Customer 2;

D₃=distance from originating point to Customer 3; and

V₃=Volume delivered to Customer 3.

The Actual Fractional Cost (AFC) for any Customer (n) on a trip is calculated as follows:

AFCₙ=(FC·FVₙ)+(VC·FDVPₘ) (6)

The resultant output from these costs calculated for the three trips (Trip 1, Trip 2 and Trip 3) are illustrated in Table 3.

TABLE 3

| | | | | | | Fractional | |
|---|---|---|---|---|---|---|---|
| | | | | | Frac- | Distance | Actual |
| | Total | | | Vari- | tional | Volume | Frac- |
| | Volume | Fixed | able | Total | Volume | Product | tional |
| Trip | Delivered | Cost | Cost | Cost | (FV) | (FDVP) | Cost |
| Trip 1 | 500000 | $500 | $201 | $701 | 0.00 | 0.00 | $— |
| Trip 1 | 500000 | $500 | $201 | $701 | 0.60 | 0.56 | $412 |
| Trip 1 | 500000 | $500 | $201 | $701 | 0.40 | 0.44 | $289 |
| Trip 1 | 500000 | $500 | $201 | $701 | 0.00 | 0.00 | $— |
| Trip 2 | 250000 | $550 | $115 | $665 | 0.00 | 0.00 | $— |
| Trip 2 | 250000 | $550 | $115 | $665 | 1.00 | 1.00 | $665 |
| Trip 2 | 250000 | $550 | $115 | $665 | 0.00 | 0.00 | $— |
| Trip 3 | 400000 | $600 | $359 | $959 | 0.00 | 0.00 | $— |
| Trip 3 | 400000 | $600 | $359 | $959 | 0.25 | 0.22 | $231 |
| Trip 3 | 400000 | $600 | $359 | $959 | 0.50 | 0.49 | $478 |
| Trip 3 | 400000 | $600 | $359 | $959 | 0.25 | 0.28 | $251 |
| Trip 3 | 400000 | $600 | $359 | $959 | 0.00 | 0.00 | $— |

Trip 1 calculations are discussed here as an example. The Total Cost for Trip 1 was $701. The Actual Fractional Costs for Customer 1 was $412. The Actual Fractional Cost for Customer 2 was $289.

Table 4 shows a consolidated version of the Actual Fractional Costs for all possible combinations of Plants and Customers involved in Trips 1-3 along with the variables involved during those trips.

TABLE 4

| | | | | | Distance from | Total | |
|---|---|---|---|---|---|---|---|
| | Assumed | | | | Originating | # of | |
| | Start Point | | | Actual | Plant to | Stops | Actual |
| | in the | Segment | | Volume | Segment End | in | Fractional |
| Trip | Model | End Point | Activity Log | Delivered | Point in Trip | Trip | Cost (Eq. 6) |
| Trip 1 | Plant 1 | Customer 1 | Delivery | 300000 | 50 | 2 | $412 |
| Trip 1 | Plant 1 | Customer 2 | Delivery | 200000 | 60 | 2 | $289 |
| Trip 2 | Plant 2 | Customer 3 | Delivery | 250000 | 40 | 1 | $665 |
| Trip 3 | Plant 3 | Customer 4 | Delivery | 100000 | 100 | 3 | $231 |
| Trip 3 | Plant 3 | Customer 5 | Delivery | 200000 | 110 | 3 | $478 |
| Trip 3 | Plant 3 | Customer 1 | Delivery | 100000 | 125 | 3 | $251 |

These calculations form the basis for performing a regression fit of the Fractional Costs as the “dependent” variable and variables like number of stops, distance from originating plant to segment end point, volume transacted during trips, and others as the “independent” variable. At least two possible regression fit scenarios may be used, including: (1) a simple linear fit, and (2) a quadratic fit although, a different combination of the variables might be chosen based on how accurately the chosen regression model predicts the actual data. At 11, the example process may fit a regression model to the fractioned costs previously calculated.

Equation 7 represents the Predicted Fractional Costs (PFC) for Customer (n) using the linear regression model, which was obtained by fitting the data from Table 4.

[[PFC]_{L}]ₙ=193.35+(7.34·Dₙ)−(315.03·S) (7)

where,
[PFC_{L}]ₙ=predicted fractional costs for any Customer (n) from the linear regression model (where the “L” subscript denotes a linear model used for the regression fit)
S=number of stops

The distance variable Dₙ, for example, may be obtained using commercially available software like Microsoft Streets and Trips® 2009 or other sources like Google® Maps, for example, since the addresses for all Plants and Customers are known.

Table 5 shows the Predicted Fractional Costs for each plant-customer combination using Equation 7 for a linear model.

TABLE 5

| Start | | | | | PFC_{L} | AFC | % Error_{L} |
|---|---|---|---|---|---|---|---|
| Point | End Point | AV | Dₙ | AS | (From Eq. 7) | (From Eq. 6) | (From Eq. 8) |
| Plant 1 | Customer 1 | 200000 | 50 | 2.5 | $123.42 | $412.00 | −70% |
| Plant 1 | Customer 2 | 200000 | 45 | 2 | $244.23 | $289.00 | −15% |
| Plant 1 | Customer 3 | 250000 | 150 | 1 | $1,417.71 | — | — |
| Plant 1 | Customer 4 | 100000 | 300 | 3 | $1,625.85 | — | — |
| Plant 1 | Customer 5 | 200000 | 325 | 3 | $1,984.67 | — | — |
| Plant 2 | Customer 1 | 200000 | 140 | 2.5 | $784.11 | — | — |
| Plant 2 | Customer 2 | 200000 | 165 | 2 | $1,125.15 | — | — |
| Plant 2 | Customer 3 | 250000 | 40 | 1 | $610.21 | $665.00 | −8% |
| Plant 2 | Customer 4 | 100000 | 250 | 3 | $1,258.80 | — | — |
| Plant 2 | Customer 5 | 200000 | 275 | 3 | $1,617.62 | — | — |
| Plant 3 | Customer 1 | 200000 | 125 | 2.5 | $674.00 | $251.00 | 169% |
| Plant 3 | Customer 2 | 200000 | 225 | 2 | $1,565.61 | — | — |
| Plant 3 | Customer 3 | 250000 | 250 | 1 | $2,151.81 | — | — |
| Plant 3 | Customer 4 | 100000 | 100 | 3 | $157.66 | $231.00 | −32% |
| Plant 3 | Customer 5 | 200000 | 110 | 3 | $406.37 | $478.00 | −15% |

A unique number for an Average Number of Stops (AS) and an Average Volume (AV) delivered for every Customer was obtained from the actual trip data over a representative time frame. Note that “AS” is used for “S” in Equation 7 and Equation 9 to calculate the Predicted Fractional Costs. Similarly “AV” is used for “V” in Equation 9 to calculate the Predicted Fractional Costs.

For example, Customer 1 was involved in product deliveries over Trip 1 and Trip 3 with the actual number of total stops being 2 and 3 respectively. Therefore, an average number of 2.5 stops are predicted for Customer 1. In real scenarios, the average number of stops is typically calculated over thousands of such trips and not just two as used here and, therefore, should be fairly representative for a Customer.

A similar approach is used for the Average Volume delivered to a Customer. For example, the Average Volume corresponding to Customer 1 is 200,000 (i.e., the average of 300,000 delivered to Customer 1 in Trip 1 and 100,000 delivered to Customer 1 in Trip 3).

Overall the Predicted Fractional Costs from the linear model for most cases are very close in magnitude to the Actual Fractional Costs incurred. There are occasional cases, however, where the Predicted Fractional Costs and the Actual Fractional Costs are different, for example, see Plant 1-Customer 1 and Plant 3-Customer 1 above. In order to quantify that, a percentage error (% Error_{L}) between the Actual Fractional Cost (AFC) and the Predicted Fractional Cost (PFC_{L}) may be obtained using Equation 8:

$$\% {Error}_{L} = \frac{( {PFC}_{L} - A F C )}{A F C} * 100 \qquad ( 8 )$$

A discrepancy in the two costs, which shows as a higher magnitude of % Error_{L} is attributed to the very limited trip data considered as an example here and the Predicted Fractional Costs will more accurately reflect the Actual Fractional Costs as the number of trips is increased.

The column for Predicted Fractional Costs in Table 5 not only shows the Predicted Fractional Costs for trips that have actually occurred in the past, but it also lists the costs for trips that were never taken and for which no historical trip data exists. For example, see the trip between Plant 1 and Customer 3 having a Predicted Fractional Cost of $1417.71.

The approach, which has been described above, has been repeated below, but for a quadratic polynomial model. Equation 9 represents the Predicted Fractional Cost (PFC_{Q}) using the quadratic polynomial regression model (where the “Q” subscript denotes a quadratic polynomial model used for the regression fit), which was obtained by fitting the data from Table 4:

[[PFC]_{Q}]ₙ−52.44+(0.0034·V)+(6.89·Dn)−(295.25·S)−(4.335−09·T·V) (9)

The % Error (% Error_{Q}) between the Actual Fractional Cost and the Predicted Fractional Cost (PFC_{Q}) was obtained using Equation 10:

$$\% {Error}_{Q} = \frac{( {PFC}_{Q} - A F C )}{A F C} * 100 \qquad ( 10 )$$

At 12, the example process may obtain a unique cost for each plant-customer combination using the regression model fitted at 11. Table 6 shows the Predicted Fractional Costs PFC_{Q} for each plant-customer combination for a quadratic polynomial model along with the % Error (% Error_{Q}) comparing the Predicted Fractional Co (PFC_{Q}) and Actual Fractional Cost.

TABLE 6

| Start | | | | | PFC_{Q} | AFC | % Error_{Q} |
|---|---|---|---|---|---|---|---|
| Point | End Point | AV | Dₙ | AS | (From Eq. 9) | (From Eq. 6) | (From Eq. 10) |
| Plant 1 | Customer 1 | 200000 | 50 | 2.5 | $165.32 | $412.00 | −60% |
| Plant 1 | Customer 2 | 200000 | 45 | 2 | $278.50 | $289.00 | −4% |
| Plant 1 | Customer 3 | 250000 | 150 | 1 | $1,369.71 | — | |
| Plant 1 | Customer 4 | 100000 | 300 | 3 | $1,530.62 | — | |
| Plant 1 | Customer 5 | 200000 | 325 | 3 | $1,912.75 | — | |
| Plant 2 | Customer 1 | 200000 | 140 | 2.5 | $785.52 | — | |
| Plant 2 | Customer 2 | 200000 | 165 | 2 | $1,105.43 | — | |
| Plant 2 | Customer 3 | 250000 | 40 | 1 | $611.69 | $665.00 | −8% |
| Plant 2 | Customer 4 | 100000 | 250 | 3 | $1,186.06 | — | |
| Plant 2 | Customer 5 | 200000 | 275 | 3 | $1,568.19 | — | |
| Plant 3 | Customer 1 | 200000 | 125 | 2.5 | $682.16 | $251.00 | 172% |
| Plant 3 | Customer 2 | 200000 | 225 | 2 | $1,518.90 | — | |
| Plant 3 | Customer 3 | 250000 | 250 | 1 | $2,058.82 | — | |
| Plant 3 | Customer 4 | 100000 | 100 | 3 | $152.40 | $231.00 | −34% |
| Plant 3 | Customer 5 | 200000 | 110 | 3 | $431.16 | $478.00 | −10% |

Again, similar trends are observed as noticed before with a higher value of error in a few cases, and the Predicted Fractional Cost (PFC_{Q}) will more accurately reflect the Actual Fractional Cost as the number of trips is increased. Also for some of the cases: Plant 1-Customer 1, Plant 1-Customer 2, Plant 3-Customer 5, the % Error goes down as compared to the linear model, which may suggest that a higher order model for fractionating costs could improve the ability to predict fractional costs.

Using the predicted costs from the linear model, the (PFC_{L}) corresponding to Plant 1-Customer 1 is $123.42 and Plant 1-Customer 2 is $244.23, thereby resulting in a total predicted trip cost of $611.88 (i.e., $123.42+$244.23+$244.23=$611.88), including the return trip cost. This is compared to the actual Total Cost of $701 for Trip 1.

Using the predicted costs from the quadratic polynomial model, the PFC_{Q} corresponding to Plant 1-Customer 1 is $165.32 and Plant 1-Customer 2 is $278.50, thereby resulting in a total predicted trip cost of $722.32 (i.e., $165.32+$278.50+$278.50=$722.32), including the return trip cost. This is compared to the actual Total Cost of $701 for Trip 1.

It is apparent from comparing the predictions from linear and quadratic polynomial models that the quadratic polynomial model provides a potentially more accurate prediction of the fractional costs corresponding to each customer-plant pairing and should be potentially preferred over a linear approach.

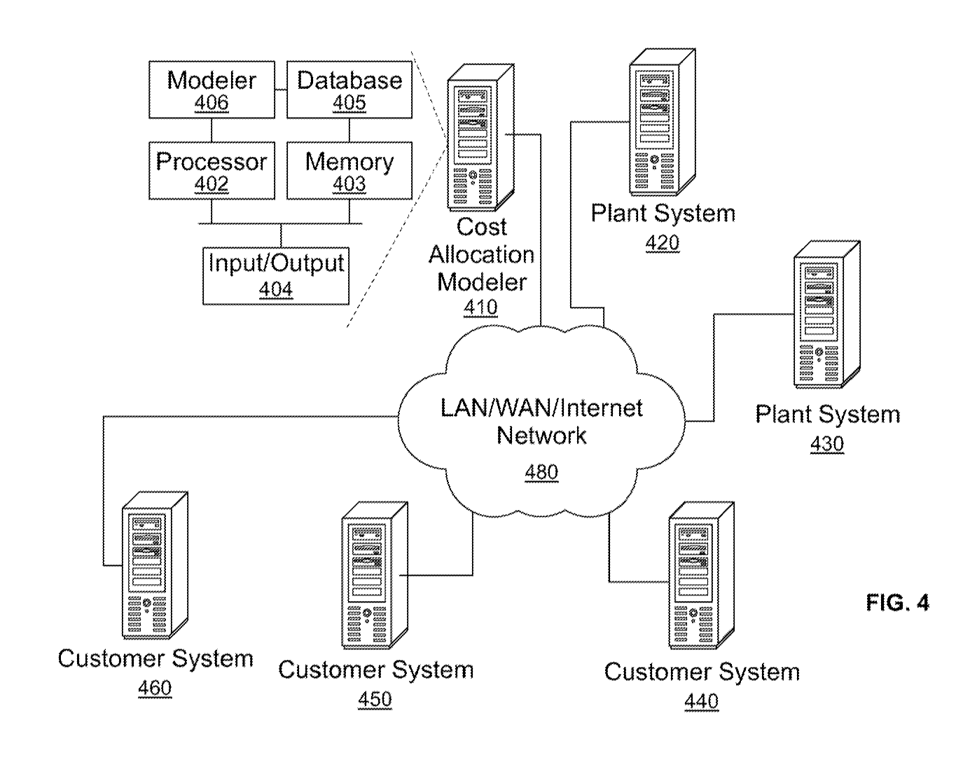

FIG. 4 illustrates one example system, according to an exemplary embodiment of the present invention. The example system may include a cost allocation modeler 410. The modeler 410 may be a server (e g., a high power general purpose computer), a plurality of local servers, and/or a plurality of geographically distributed servers. Each server, including modeler 410, may have one or more system memories 403, e.g., Random Access Memory (RAM), Read Only Memory (ROM), hard disks, solid-state drives, disk arrays, and any number of other data storage technologies. One or more databases 405 may be constructed within one or more of the memory arrangements 403. The memory may be connected via a bus to one or more processors 402. This may include one or more general purpose electronic processors, special purposes processors, single or multi-core processors, other suitable data processing arrangements, and/or any combination of the above. The bus may also include one or more input or output devices 404, including network connections, monitors, data cables, keyboards, mice, touch-pads, touch screens, speakers, and/or any number of other input and/or output devices. Cost allocation modeler 410 may also have a modeler module 406, connected to the memory for storage and processor for execution. The modeler system 410 may be connected via a network (e.g., the Internet) to servers located at plant locations (e.g., 420 and 430), and/or customer locations (e.g., 440, 450, and 460). These connections may provide communication (e a., email), software functions (e.g., invoicing), and data sharing (e.g., operational statistics).

While aspects of the present invention have been described in connection with the preferred embodiments of the various figures, it is to be understood that other similar embodiments may be used or modifications and additions may be made to the described embodiment for performing the same function of the present invention without deviating there from. For instance, the examples illustrated in the document refer to fractionation of the costs from actual trips and allocating them to unique customer-plant pairings, a similar approach could be used in fractionating other resources and/or variables as well to various plant-customer pairings. Among others, some examples of these resources and/or variables may include the number of driver hours available at any production plant for carrying out the proposed trips, the number of vehicles (including trucks and/or tankers) available at any production plant to carry product for the proposed trips, maintenance hours, depreciation of assets, etc. Therefore, the claimed invention should not be limited to any single embodiment, but rather should be construed in breadth and scope in accordance with the appended claims.

Further, it will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor which, when executing the series of computer instructions, performs or facilitates the performance of all or part of the disclosed methods and procedures.

1. A computer-implemented method for fractionating and allocating a cost of delivery of a product to at least one customer from at least one plant, wherein the at least one customer is at a first location and requires a first amount of the product to be delivered, and wherein the plant is at a second location and has a capacity to produce and distribute a second amount of the product, the method comprising:
a. obtaining, with an electronic processor from an electronic data repository, historical actual trip data for the at least one customer receiving the product from the at least one plant;
b. eliminating, with the electronic processor, outlier data from the historical actual trip data to calculate cleaned trip data;
c. calculating, with the electronic processor, a fixed cost for delivery of the product to the at least one customer using the cleaned trip data;
d. calculating, with the electronic processor, a variable cost for the delivery of the product to the at least one customer using the cleaned trip data;
e. calculating, with the electronic processor, an actual fractional cost for the delivery of the product to the at least one customer from the second location; and
f. calculating, with the electronic processor, a predicted fractional cost for the delivery of the product to the at least one customer from the second location.

2. The method of claim 1, further comprising calculating, with the electronic processor: (i) an average number of stops made to the at least one customer; and (ii) an average amount of the product delivered to the at least one customer.

3. The method of claim 1, wherein the historical actual trip data comprises actual trip data over a one-year period.

4. The method of claim 1, further comprising calculating, with the electronic processor, a plurality of variables, which allow a customer grouping to be established.

5. The method of claim 4, wherein the plurality of variables comprise at least one of a customer type and an average number of stops for each customer over a certain period of time.

6. The method of claim 1, further comprising for a new customer at a third location: calculating, with the electronic processor, a predicted fractional cost for the delivery of a new amount of product to the new customer from the second location.

7. A computer system for fractionating and allocating a cost of delivery of a product to at least one customer from at least one plant, wherein the at least one customer is at a first location and requires a first amount of the product to be delivered, and wherein the plant is at a second location and has a capacity to produce and distribute a second amount of the product, the system comprising:
an electronic data repository: and
an electronic processor, configured to;
a. obtain, from the electronic data repository, historical actual trip data for the at least one customer receiving the product from the at least one plant;
b. eliminate outlier data from the historical actual trip data to calculate cleaned trip data;
c. calculate a fixed cost for delivery of the product to the at least one customer using the cleaned trip data;
d. calculate a variable cost for the delivery of the product to the at least one customer using the cleaned trip data;
e. calculate an actual fractional cost for the delivery of he product to the at least one customer from the second location; and
f. calculate a predicted fractional cost for the delivery of the product to the at least one customer from the second location.

8. The system of claim 7, wherein the electronic processor is further configured to calculate an average number of stops made to the at least one customer and to calculate an average amount of the product delivered to the at least one customer.

9. The system of claim 7, wherein the historical actual trip data comprises actual rip data over a one-year period.

10. The system of claim 7, wherein the electronic processor is further configured to calculate a plurality of variables, which allow a customer grouping to be established.

11. The system of claim 10, wherein the plurality of variables comprise at least one of a customer type and an average number of stops for each customer over a certain period of time.

12. The system of claim 7, wherein the electronic processor is further configured to calculate for a new customer at a third location a geographic distance between the second location and the third location, to determine a third amount of the product representing an estimated amount needed by the new customer, and to calculate a predicted fractional cost for the delivery of the third amount of the product to the new customer from the second location.

13. A computer-readable storage medium encoded with instructions configured to be executed by a processor, the instructions which, when executed by the processor, cause the performance of a method for fractionating and allocating a cost of delivery of a product to an at least one customer from an at least one plant, wherein the at least one customer is at a first location and requires a first amount of the product to be delivered, and wherein the plant is at a second location and has a capacity to produce and distribute a second amount of the product, the method comprising:
a. obtaining, with an electronic processor, historical actual trip data for the at least one customer receiving the product from the at least one plant;
b. eliminating, with the electronic processor, outlier data from the historical actual trip data to calculate cleaned trip data;
c. calculating, with the electronic processor, a fixed cost for delivery of the product to the at least one customer using the cleaned trip data;
d. calculating, with the electronic processor, a variable cost for the delivery of the product to the at least one customer using the cleaned trip data;
e. calculating, with the electronic processor, an actual fractional cost for the delivery of the product to the at least one customer from the second location; and
f. calculating, with the electronic processor, a predicted fractional cost for the delivery of the product to the at least one customer from the second location.

14. The method of claim 13, wherein the first mount is equal to the second amount.

15. The method of claim 13, wherein the historical actual trip data comprises actual trip data over a one-year period.

16. The method of claim 13, further comprising calculating, with the electronic processor, a plurality of variables, which allow a customer grouping to be established.

17. The method of claim 16, wherein the plurality of variables comprise at least one of a customer type and an average number of stops for each customer over a certain period of time.

18. The method of claim 13, further comprising for a new customer at a third location:
calculating, with the electronic processor, a geographic distance between the second location and the third location;
determining a third amount of the product representing an estimated amount needed by the new customer;
calculating, with the electronic processor, an estimated number of stops made to the new customer, based on user input; and
calculating, with the electronic processor, a predicted fractional cost for the delivery of the third amount of the product to the new customer from the second location.

19. The method of claim 13, further comprising calculating, with the electronic processor, an average number of stops made to the at least one customer.

20. The method of claim 10, further comprising calculating, with the electronic processor, an average amount of the product delivered to the at least one customer.
